(19) United States
(12) Patent Application Publication
(10) Pub. No.: US 2025/0020817 A1
(43) Pub. Date: Jan. 16, 2025

(54) RADIATION DETECTOR AND DETECTION SYSTEM

(71) Applicant: CANON KABUSHIKI KAISHA, Tokyo (JP)

(72) Inventors: TATSUHITO GODEN, Tokyo (JP); TAKANORI WATANABE, Kanagawa (JP)

(21) Appl. No.: 18/769,262

(22) Filed: Jul. 10, 2024

(30) Foreign Application Priority Data
Jul. 11, 2023 (JP) 2023-113804

(51) Int. Cl. G01T 1/24

(52) U.S. Cl. CPC G01T 1/243

(57) ABSTRACT

A radiation detector includes a pixel region in which a plurality of pixels is arranged, a peripheral circuit region in which a signal processing circuit that processes a signal from the plurality of pixels is provided, and a first intermediate region arranged between the pixel region and the peripheral circuit region, wherein the first intermediate region includes a first conductive layer arranged in contact with the insulating layer, and wherein the first conductive layer is configured to be supplied with a predetermined potential.

### BACKGROUND

### Field

The present disclosure relates to a radiation detector and a detection system.

### Description of the Related Art

As a detector that can detect visible light and radiation (energy rays) such as X-rays, there is known a detector in which a detection element has a pixel structure similar to a complementary metal oxide semiconductor (CMOS) image sensor. For example, a radiation detector has been discussed that is provided with a shielding member having an opening through which a peripheral circuit region is not irradiated with radiation and a pixel region is irradiated with radiation.

In recent CMOS image sensors, a pixel region and a peripheral circuit region are integrally formed on one semiconductor chip, and a chip size has been reduced and the number of pixels has been increased. Accordingly, a wiring portion needs to be miniaturized, and an interlayer insulating film is planarized using chemical mechanical polishing (CMP). At this time, if a pattern density of a conductive layer is different between the pixel region and the peripheral circuit region, CMP polishing rates for interlayer insulating layers disposed on the respective regions will differ. Accordingly, a height difference occurs in a film thickness of the interlayer insulating film between the pixel region and the peripheral circuit region, which affects characteristics of a CMOS image sensor.

In contrast, according to Japanese Patent Application Laid-Open No. 2008-98373, a technique is discussed in which a dummy pattern is arranged in a conductive layer forming a gate electrode to reduce a height difference in a film thickness of an interlayer insulating film.

A radiation detector may have a configuration in which a buffer region is provided between a pixel region and a peripheral circuit region by taking into account a variation in alignment between an opening of a shielding member and a pixel region including a detection element and spread of radiation that goes around from the opening of the shielding member to the peripheral circuit region. In this case, as described above, in order to planarize an interlayer insulating film by CMP, it is conceivable to arrange a dummy pattern in the buffer region as well, as discussed in Japanese Patent Application Laid-Open No. 2008-98373.

The dummy pattern according to Japanese Patent Application Laid-Open No. 2008-98373 is not electrically connected to any of surrounding patterns and is floating. Since the buffer region can be irradiated with radiation depending on a position of a shielding member, the floating dummy pattern may be charged up by being irradiated with radiation. If the dummy pattern is charged up, a dielectric breakdown occurs in an insulating layer adjacent to the dummy pattern, and the radiation detector may break down.

### SUMMARY

The present disclosure is generally directed to the provision of a radiation detector in which a dielectric breakdown of an insulating layer due to charge-up of a dummy pattern is suppressed even when the dummy pattern is arranged in a buffer region between a pixel region and a peripheral circuit region in consideration of the above-described issues.

According to some embodiments, a radiation detector includes a pixel region in which a plurality of pixels is arranged, a peripheral circuit region in which a signal processing circuit that processes a signal from the plurality of pixels is provided, and a first intermediate region arranged between the pixel region and the peripheral circuit region, wherein each of the plurality of pixels includes a radiation detection element provided on a semiconductor substrate, and a transistor that outputs a signal corresponding to a charge accumulated in the radiation detection element, wherein, in the pixel region, the first intermediate region, and the peripheral circuit region, an insulating layer is arranged on the semiconductor substrate, and an interlayer insulating layer is arranged on the insulating layer, wherein the transistor includes a gate electrode provided on the insulating layer, wherein the first intermediate region includes a first conductive layer arranged in contact with the insulating layer, wherein the first conductive layer is configured to be supplied with a first potential, and wherein a distance between the pixel region and the peripheral circuit region is 200 μm or more.

According to some other embodiments, a radiation detector includes a pixel region in which a plurality of pixels is arranged, a peripheral circuit region in which a signal processing circuit that processes a signal from the plurality of pixels is provided, and a first intermediate region arranged between the pixel region and the peripheral circuit region, wherein each of the plurality of pixels includes a radiation detection element provided on a semiconductor substrate, and a transistor that includes a gate electrode and outputs a signal corresponding to a charge accumulated in the radiation detection element, wherein the first intermediate region includes an insulating layer arranged on the semiconductor substrate and a first conductive layer that is arranged on the insulating layer and includes polysilicon, wherein an interlayer insulating layer is arranged on the radiation detection element, the transistor, and the first conductive layer, wherein the first conductive layer is configured to be supplied with a first potential, and wherein a distance between the pixel region and the peripheral circuit region is 200 μm or more.

Further features of the present disclosure will become apparent from the following description of exemplary embodiments with reference to the attached drawings.

### BRIEF DESCRIPTION OF THE DRAWINGS

FIG. 1A illustrates an example of a radiation detector according to a first exemplary embodiment. FIG. 1B illustrates an electrical configuration of the radiation detector according to the first exemplary embodiment.

FIG. 2 illustrates an example of a pixel configuration of the radiation detector according to the first exemplary embodiment.

FIG. 3 is a cross-sectional view of a part of the radiation detector according to the first exemplary embodiment.

FIG. 4A illustrates an example of a first buffer region according to the first exemplary embodiment. FIG. 4B is a plan view illustrating a first wiring layer in a configuration in FIG. 4A. FIG. 4C is a cross-sectional view taken along an A-A′ line in FIG. 4B.

FIG. 5A illustrates an example of a first buffer region according to a second exemplary embodiment. FIG. 5B is a plan view illustrating a first wiring layer in a configuration in FIG. 5A. FIG. 5C is a cross-sectional view taken along a B-B′ line in FIG. 5B.

FIG. 6A illustrates an example of a first buffer region according to a third exemplary embodiment. FIG. 6B is a plan view illustrating a first wiring layer in a configuration in FIG. 6A. FIG. 6C is a cross-sectional view taken along a C-C′ line in FIG. 6B.

FIG. 7 illustrates an example of a radiation detector according to a fourth exemplary embodiment.

FIG. 8 illustrates an example of a radiation detector according to a fifth exemplary embodiment.

FIG. 9A illustrates an example of a first buffer region and a second buffer region according to the fifth exemplary embodiment. FIG. 9B is a plan view illustrating a first wiring layer in a configuration in FIG. 9A. FIG. 9C is a cross-sectional view taken along a D-D′ line in FIG. 9B.

FIG. 10A illustrates an example of a pixel region, the first buffer region, and the second buffer region of the radiation detector according to the fifth exemplary embodiment. FIG. 10B is a cross-sectional view taken along an E-E′ line in FIG. 10A.

FIG. 11 illustrates an example of a pixel region, a first buffer region, and a second buffer region of a radiation detector according to a sixth exemplary embodiment.

FIG. 12 illustrates an example of a radiation detector according to a seventh exemplary embodiment.

FIG. 13 illustrates an example of a radiation detector according to an eighth exemplary embodiment.

FIG. 14 illustrates a radiation imaging system according to a ninth exemplary embodiment.

FIG. 15 illustrates a detection system provided with a radiation detector according to a tenth exemplary embodiment.

### DESCRIPTION OF THE EMBODIMENTS

Various exemplary embodiments, features, and aspects according to the present disclosure will be described below with reference to the attached drawings. The present disclosure is not limited to the following exemplary embodiments and can be appropriately modified without departing from the scope of the present disclosure.

In the drawings described below, parts having the same functions are denoted by the same reference numerals, and descriptions thereof may be omitted or simplified.

In the following exemplary embodiments, a case is described in which an electron is used as a signal charge, but a radiation detector may also use a hole as a signal charge. In a case where a hole is used as a signal charge, a positive (P)-type semiconductor region may be replaced with a negative (N)-type semiconductor region, and an N-type semiconductor region may be replaced with a P-type semiconductor region.

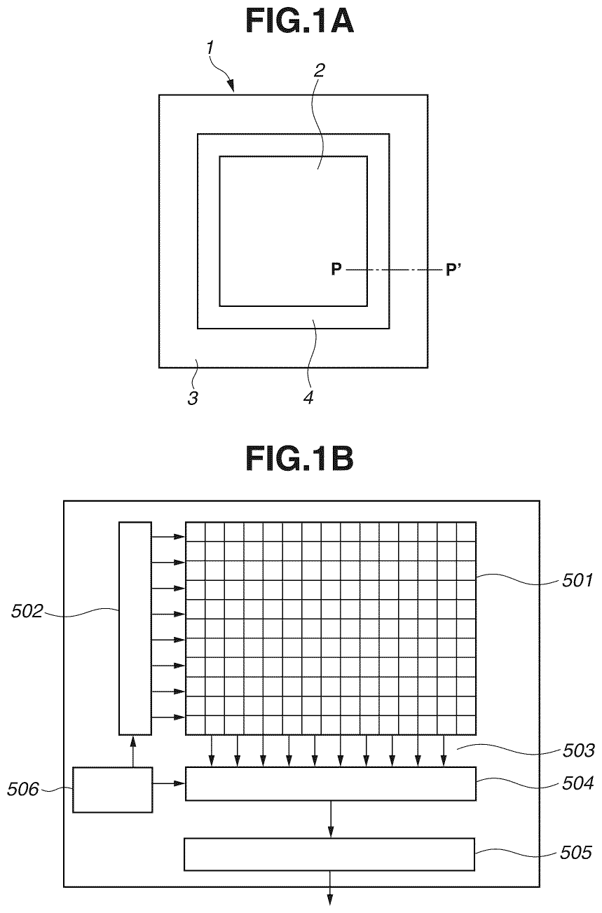

A radiation detector according to a first exemplary embodiment will be described with reference to FIGS. 1A to 3. FIG. 1A illustrates an example of the radiation detector according to the present exemplary embodiment. A radiation detector 1 uses a semiconductor substrate made of silicon or the like as a substrate and includes a pixel region 2, a peripheral circuit region 3, and a first buffer region (first intermediate region) 4 adjacent to the peripheral circuit region 3 and arranged between the pixel region 2 and the peripheral circuit region 3. The pixel region 2 includes a plurality of pixels, and the peripheral circuit region 3 includes a signal processing circuit that processes a signal from the plurality of pixels.

According to the present exemplary embodiment, the first buffer region 4 is arranged to surround the pixel region 2. For example, in the pixel region 2, many pixels are two-dimensionally arranged. A charge generated by irradiated radiation is accumulated in each pixel, and a pixel signal corresponding to an amount of accumulated charges is output.

FIG. 1B is a block diagram illustrating a configuration example of a part of the radiation detector 1. The part of the radiation detector 1 includes a pixel array 501 in which the pixels illustrated in FIG. 1A are arranged in a two-dimensional matrix, a vertical scanning circuit 502, a vertical signal line 503, a readout circuit 504, a digital front end (DFE) 505, and a timing generator 506.

The vertical scanning circuit 502 selects a pixel row to output a signal from the pixel array 501 and sequentially operates the pixel rows by controlling a selection (SEL) voltage or a reset (RES) voltage. A signal (pixel signal) is input from a pixel selected by the vertical scanning circuit 502 to the vertical signal line 503. The readout circuit 504 processes a signal input from the vertical signal line 503. The DFE 505 outputs a signal input from the readout circuit 504 to the outside of the radiation detector 1. The timing generator 506 controls timing of circuit operations of the vertical scanning circuit 502 and the readout circuit 504.

FIG. 1B illustrates the radiation detector 1 that includes the pixel array 501 arranged in a two-dimensional matrix, but the radiation detector 1 according to the present exemplary embodiment may include a pixel region in which a plurality of pixels is arranged in a one-dimensional straight line according to intended usage.

According to the present exemplary embodiment, the pixel region 2 may include only effective pixels, and if the radiation detector 1 includes a non-effective pixel and a dummy pixel besides the effective pixels, the pixel region 2 includes all of these pixels.

The peripheral circuit region 3 includes the signal processing circuit that processes a signal from a pixel, and the signal processing circuit includes, for example, at least one of the vertical scanning circuit 502, the readout circuit 504, the DFE 505, which is a signal output circuit, and the timing generator 506.

The vertical scanning circuit 502 outputs a control signal to sequentially drive the pixels in the pixel region 2 row by row. The readout circuit 504 may include a column amplifier, a correlated double sampling (CDS) circuit, an adding circuit, and an analog-to-digital (A/D) conversion circuit. A pixel signal is read from a pixel in the row selected by the vertical scanning circuit 502 via the vertical signal line and is output to the A/D conversion circuit in the readout circuit 504.

The pixel signal input to the A/D conversion circuit is converted from an analog signal to a digital signal.

The signal output circuit transmits the digital signal output from the A/D conversion circuit to an external apparatus as an image signal using a predetermined method. The timing generator 506 receives a control signal from the external apparatus and transmits timing signals to the vertical scanning circuit 502, the readout circuit 504, and the DFE 505 (signal output circuit) to control operations of the respective circuits.

The radiation detector 1 is provided with a shielding member (not illustrated), and the pixel region 2 is irradiated with radiation through an opening provided in the shielding member. The peripheral circuit region 3 is shielded from radiation by the shielding member. The first buffer region 4 is a region arranged between the pixel region 2 and the peripheral circuit region 3 by taking into account a variation in alignment of the shielding member and spread of radiation that goes around from the opening of the shielding member to the peripheral circuit region 3.

Considering scattering of radiation within a semiconductor substrate 10, it is desirable that a distance between the pixel region 2 and the peripheral circuit region 3 is 200 μm (micrometers) or more. In addition, considering a transmission rate of a pixel signal and a control signal between the pixel region 2 and the peripheral circuit region 3, it is desirable that the distance is 2000 μm or less. A more detailed configuration of the first buffer region 4 will be described below.

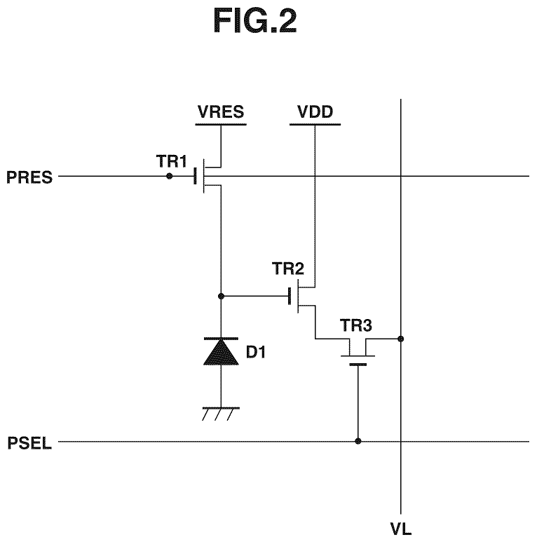

FIG. 2 illustrates an example of each pixel in the pixel region 2. Each pixel includes a detection diode D1, which is a radiation detection element, and a transistor that outputs a signal corresponding to a charge accumulated in the radiation detection element. An example will be described below in which a charge accumulated in the detection diode D1, which is the radiation detection element, is an electron. Further, according to the present exemplary embodiment, an example will be described in which all transistors included in a pixel are N-type transistors.

On the other hand, a charge accumulated in the detection diode D1 may be a hole, and in this case, the transistors of the pixel may be P-type transistors. In other words, a definition of a conductivity type used in the following description can be changed according to a polarity of a charge handled as a signal.

In FIG. 2, the detection diode D1, which is a photoelectric conversion unit, is provided within the semiconductor substrate 10, and a cathode of the detection diode D1 is connected to a source of a reset transistor TR1 and a gate of an amplifying transistor TR2. An anode of the detection diode D1 is connected to an impurity region within the semiconductor substrate 10 to which a ground (GND) potential is supplied.

A drain of the reset transistor TR1 is connected to a power supply voltage VRES, and it is configured so that the power supply voltage VRES can be written to the cathode of the detection diode D1 via the reset transistor TR1. Further, a drain of the amplifying transistor TR2 is connected to a power supply voltage VDD. A potential of the power supply voltage VRES and a potential of the power supply voltage VDD may be the same potential.

A source of the amplifying transistor TR2 is connected to the vertical signal line 503 via a selection transistor TR3. A reset signal PRES is input to a gate of the reset transistor TR1, and a selection signal PSEL is input to a gate of the selection transistor TR3.

The vertical signal line 503 is connected to a current source (not illustrated). If the selection signal PSEL reaches an active level, the selection transistor TR3 turns on. Accordingly, the amplifying transistor TR2 is supplied with a current from the current source. The power supply voltage VDD, the amplifying transistor TR2, and the current source (not illustrated) connected to the vertical signal line 503 form a source follower circuit.

The source follower circuit is formed, and thus the amplifying transistor TR2 outputs a signal based on a potential of the cathode of the detection diode D1, that is, a signal corresponding to the charge accumulated in the detection diode D1 to the vertical signal line 503 via the selection transistor TR3.

The pixel according to the present exemplary embodiment may be a pixel including three transistors as illustrated in FIG. 2. Further, the pixel may include four transistors including a transfer transistor provided in an electrical path between the detection diode D1 and a gate of the amplifying transistor TR2. Furthermore, the pixel may have a global shutter structure that further includes a memory and a second transfer transistor for transfer between the transfer transistor and the gate of the amplifying transistor TR2.

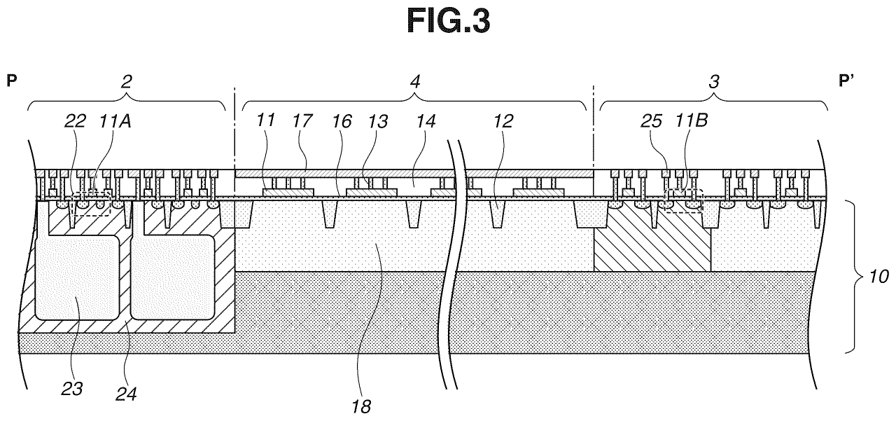

FIG. 3 is a cross-sectional view of a part of the pixel region 2, the peripheral circuit region 3, and the first buffer region 4 according to the present exemplary embodiment, taken along a P-P′ line in FIG. 1A. According to the present exemplary embodiment, an example is described in which an insulating layer 16 is provided on the semiconductor substrate 10 in the pixel region 2, the peripheral circuit region 3, and the first buffer region 4. In this example, the insulating layer 16 is in contact with the semiconductor substrate 10.

The pixel region 2 includes the detection diode D1, which is the radiation detection element, and a transistor 22 that is configured to output a signal corresponding to the charge accumulated in the detection diode D1. The transistor 22 includes the insulating layer 16 provided on the semiconductor substrate 10 as a gate insulating film, and a conductive layer 11A provided on the insulating layer 16 and including polysilicon as a gate electrode. The detection diode D1 includes a first conductivity type second impurity region 24, which is a pixel well, and a third impurity region 23 that is arranged within the second impurity region 24 and has a second conductivity type different from the first conductivity type.

The peripheral circuit region 3 includes a transistor forming the signal processing circuit and includes, for example, a transistor 25 in FIG. 3. The transistor 25 also includes the insulating layer 16 as a gate insulating film, and a conductive layer 11B provided on the insulating layer 16 and including polysilicon as a gate electrode.

The first buffer region 4 includes a first conductivity type first impurity region 18, and a conductive layer 11 that is arranged to be in contact with the insulating layer 16 on the semiconductor substrate 10 and is formed from the same layer as the conductive layers 11A and 11B. The conductive layer 11 is arranged as a dummy conductive layer in the first buffer region 4 and is provided not for applying a voltage or supplying a current to other elements, but for improving flatness of an interlayer insulating layer arranged on the conductive layer 11.

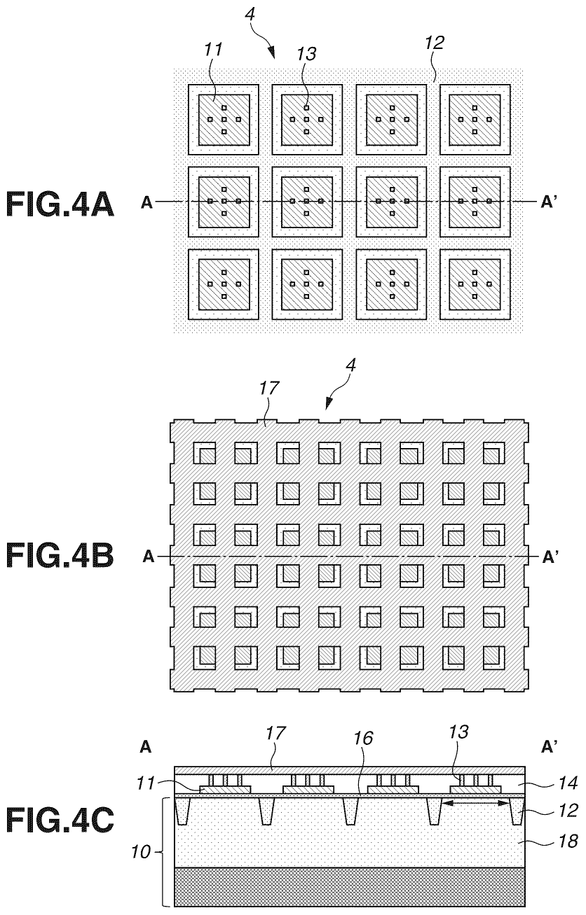

FIGS. 4A to 4C illustrate the first buffer region 4 according to the present exemplary embodiment. FIG. 4A is a plan view of an example of the radiation detector 1, and a first wiring layer 17 is not illustrated for convenience of description. FIG. 4B is a plan view illustrating the first wiring layer 17 in the configuration in FIG. 4A. FIG. 4C is a cross-sectional view taken along an A-A′ line in FIG. 4B.

In the first buffer region 4 illustrated in FIGS. 4A and 4C, the first impurity region 18, which is a first well, is formed on the semiconductor substrate 10, and an insulating material 12 is arranged in a grid pattern on the first impurity region 18. The insulating material 12 is formed using, for example, silicon oxide, and can be manufactured using local oxidation of silicon (LOCOS) and shallow trench isolation (STI) in the same process as that of an insulating material element isolation portion of the transistor. According to the present exemplary embodiment, the insulating material 12 may be at least one of LOCOS and STI, and thus, the first buffer region 4 may include both the insulating material 12 of LOCOS and the insulating material 12 of STI.

The insulating material element isolation portion of the transistor in the pixel region 2 and the peripheral circuit region 3 is also generally arranged in a grid pattern, so that the insulating material and the insulating material element isolation portion can be arranged in a grid pattern for an entire radiation detector 1. Thus, a manufacturing condition is stable in a surface of the semiconductor substrate 10, and it is possible to suppress forming defects in LOCOS and STI. Accordingly, flatness of an interlayer insulating layer 14 is secured in a case where the interlayer insulating layer 14 is planarized by chemical mechanical polishing (CMP), and reduction in manufacturing yield can be suppressed.

In a case where the insulating material 12 is formed using STI, the insulating material 12 is planarized by CMP, so that it is desirable that an area density of the insulating material 12 is 75% or less. Further, a thickness of the insulating material 12 is desirably 100 nm to 500 nm (nanometers).

The conductive layer 11, which is a dummy conductive layer (dummy pattern), is arranged in a region on the first impurity region 18 where the insulating material 12 is not provided. As described above, the conductive layer 11 is the same layer as the gate electrode of the transistor, and is formed using, for example, polysilicon in the same process.

The insulating layer 16 that functions as a gate insulating film of the transistor is arranged between the conductive layer 11 and the first impurity region 18 in the pixel region 2 and the peripheral circuit region 3. A thickness of the insulating layer 16 is desirably less than 100 nm. The conductive layer 11 is formed into a small pattern arranged like islands, and thus antenna damage due to charge-up during etching in a manufacturing process can be suppressed.

An area of the conductive layer 11 is set to have a desired area density, so that in a case where CMP is performed on the interlayer insulating layer 14 on the conductive layer 11, a film thickness difference between the interlayer insulating layers in the pixel region 2 and the peripheral circuit region 3 can be reduced, and the manufacturing yield can be improved.

Here, the area density of the conductive layer 11 refers to a ratio of the area of the conductive layer 11 to an area of a region of one repeating unit in a region including the conductive layer 11 in a plan view illustrated in FIG. 4A. For example, FIG. 4A illustrates a region including 12 repeating units, and the area density of the conductive layer 11 is the ratio of the area of one conductive layer 11 to the area of the region in one of the repeating units. According to the present disclosure, an area density of a member A is a ratio of an area of the member A to an area of a region of one repeating unit in a region including the member A in a plan view.

The gate electrodes of the transistors arranged on the conductive layer 11 and the pixel region 2 do not need to have the same shape and size with each other and may have different shapes and sizes according to respective criteria.

In the pixel region 2, by reducing a region occupied by the transistor, it is possible to increase a volume of the detection diode D1 per pixel and to improve sensitivity. In this case, the gate electrode of the transistor also becomes smaller, and the area density of the gate electrode in the pixel region 2 is lowered.

On the other hand, the detection diode D1 is not arranged in the first buffer region 4, so that there is no limitation in a size of the conductive layer 11 (first conductive layer). On the other hand, in a case where the area density of the gate electrode in the pixel region 2 is small, the area density of the first conductive layer 11 in the first buffer region 4 is increased, and accordingly the flatness of the interlayer insulating layer 14 can be further improved in a CMP process for forming the interlayer insulating layer 14.

Thus, it is desirable that the area of the conductive layer 11 arranged in the first buffer region 4 is larger than an area of the gate electrode of the transistor in the pixel region 2 in a plan view from a vertical direction to a surface on which the conductive layer 11 of the semiconductor substrate 10 is arranged. For example, it is desirable that the area of the conductive layer 11 is twice or more of the area of the gate electrode of the transistor. According to the present exemplary embodiment, the area of the conductive layer 11 is approximately 36 times larger than the area of the gate electrode of the transistor 22 arranged in the pixel region 2. Accordingly, the flatness of the interlayer insulating layer 14 arranged on the conductive layer 11 and the transistor in the pixel region 2 can be improved.

The area density of the conductive layer 11 is desirably 5% to 70%. In a cross-sectional view, the insulating material 12 tends to be higher than an upper surface of the semiconductor substrate 10. Thus, arranging the conductive layer 11 in a portion of the semiconductor substrate 10 that is not covered with the insulating material 12 is advantageous because it is possible to reduce unevenness of a base of the interlayer insulating layer 14 in planarizing the interlayer insulating layer 14 by CMP.

The first wiring layer 17 is arranged on the conductive layer 11 via the interlayer insulating layer 14, and the conductive layer 11 is connected to the first wiring layer 17 via a plug 13. The first wiring layer 17 is applied with a ground potential or a potential of power supply used in the pixel region 2 and the peripheral circuit region 3, and thus, the potential is also applied to the conductive layer 11. Thus, even when the conductive layer 11 is irradiated with radiation and becomes charged up, the charge can be discharged. Accordingly, it is possible to suppress a breakdown of the insulating layer 16 due to charge-up of the conductive layer 11 and reduction in radiation detection performance due to an increase in dark current.

The potential applied to the first impurity region 18 may be any potential, such as the ground potential or the potential of the power supply used in the pixel region 2 and the peripheral circuit region 3, as long as it is a predetermined potential. The insulating layer 16 is sandwiched between the first impurity region 18 and the conductive layer 11 in the first buffer region 4. Thus, in a case where the conductive layer 11 is in a floating state where it is not connected to anything and a potential is not supplied, if the conductive layer 11 is irradiated with radiation and becomes charged up, an unexpected electric field is applied to the insulating layer 16 by the first impurity region 18 and the conductive layer 11. In addition, strength of the electric field is not constant and difficult to predict.

Thus, if the conductive layer 11 in the floating state is irradiated with radiation, a dielectric breakdown may occur in the insulating layer 16 due to charge-up of the conductive layer 11.

However, the radiation detector 1 is configured so that a predetermined potential (first potential) is supplied to the conductive layer 11, and it is possible to prevent the conductive layer 11 from charging up by radiation. Thus, a dielectric breakdown of the insulating layer 16 can be suppressed.

Further, the conductive layer 11 is configured to be supplied with the same potential as the first impurity region 18, and thus the electric field applied to the insulating layer 16 in the first buffer region 4 is reduced and theoretically becomes zero. Accordingly, generation of dark current due to accumulation of charge in the insulating layer 16 can be more effectively suppressed, and as a result, a noise signal due to the dark current can be suppressed.

In a case where the potential of the first impurity region 18 in the first buffer region 4 is set to the ground potential, holes generated in the insulating layer 16 and the semiconductor substrate 10 due to radiation can be discharged. Thus, an influence of the dark current on detection performance can be further suppressed. In addition, a potential of an impurity region (well) arranged in the adjacent pixel region 2 can be stabilized.

On the other hand, in a case where the potential of the first impurity region 18 in the first buffer region 4 is set to the power supply potential, it is possible to collect electrons generated by radiation irradiation. Thus, it is possible to suppress an influence of noise on a pixel signal in the pixel region 2 and to suppress a malfunction and a latch-up in the peripheral circuit region 3 due to the electron going around.

If the first impurity region 18 is a P-type semiconductor, it is desirable to apply the ground potential to the first impurity region 18. If the first impurity region 18 is an N-type semiconductor, it is desirable to apply the power supply potential higher than the ground potential to the first impurity region 18.

In order to make the first impurity region 18 and the conductive layer 11 have the same potential, the first wiring layer 17 and the first impurity region 18 may be connected via a plug. Impurity ions having the same conductivity type as the first impurity region 18 are implanted into a surface of the first impurity region 18 to which the plug is connected, so that connection resistance can be lowered, and noise due to a potential variation can be suppressed.

A configuration may be adopted in which a wire (not illustrated) is connected to the first impurity region 18 to share the predetermined potential, and the first wiring layer 17 is connected to another wire that supplies the same potential.

In FIG. 4B, the first wiring layer 17 is arranged in a grid pattern. The first wiring layer 17 can be set to a desired area density by adjusting a wiring width, so that when CMP is performed on the interlayer insulating layer 14 on the first wiring layer 17, a film thickness difference between the interlayer insulating layers in the pixel region 2 and the peripheral circuit region 3 can be reduced, and the manufacturing yield can be improved. The area density of the first wiring layer 17 is desirably 10% to 85%.

As a material forming the interlayer insulating layer 14, for example, silicon oxide and boro-phospho-silicate glass (BPSG) can be used. Further, phosphorous silicate glass (PSG), boro-silicate glass (BSG), silicon nitride, and silicon carbide can also be used. As a material forming the wiring layer and the plug, for example, a conductive material such as copper, aluminum, tungsten, tantalum, titanium, polysilicon, and an alloy thereof can be used.

In a case where one or more wiring layers is further arranged on the first wiring layer 17 and any of wires is floating, if the floating wire is irradiated with radiation, the wire is charged up. Then, an electric field is applied between the floating wire and a wire adjacent thereto, which may cause a dielectric breakdown of the interlayer insulating layer therebetween.

Thus, it is desirable that a configuration is adopted in which the floating wire is supplied with the ground potential or the power supply potential used in the pixel region 2 and the peripheral circuit region 3. With this configuration, even when the wire is irradiated with radiation, a generated charge can be discharged. Thus, the interlayer insulating layer can be suppressed from a breakdown due to charge-up.

The vertical signal line 503 connected to the pixel region 2 and control signal lines of the reset signal PRES and the selection signal PSEL may extend to the first buffer region 4. The vertical signal line 503 and the control signal line can be formed in the first wiring layer 17 or a wiring layer above it.

The conductive layer 11 can be formed from, for example, the same conductive film as the gate electrode of the transistor 22 in the pixel region 2 and include the same material. With this configuration, the number of forming processes and materials used can be reduced compared with forming the gate electrode of the transistor 22 and the conductive layer 11 in separate processes, whereby productivity can be improved. However, the radiation detector 1 according to the present disclosure is not limited to this configuration. The transistor 22 in the pixel region 2 and the conductive layer 11 may be formed in separate processes.

According to the present exemplary embodiment, the conductive layer 11 is arranged on the first impurity region 18 via the insulating layer 16, but a part of the conductive layer 11 may be arranged on the insulating material 12. Even in this case, it is possible to suppress the dielectric breakdown of the insulating layer 16 due to charge-up and generation of dark current due to accumulation of charge in the insulating film as described in the present exemplary embodiment.

As described above, the radiation detector 1 according to the present exemplary embodiment includes the first buffer region 4 and can secure an alignment margin of the shielding member. Further, since the first buffer region 4 includes the conductive layer 11 as a dummy conductive layer, a difference in height of the interlayer insulating layer among the pixel region 2, the peripheral circuit region 3, and the first buffer region 4 can be reduced, and flatness can be improved.

In addition, the conductive layer 11 in the first buffer region 4 is connected to the first wiring layer 17 via the plug 13 and applied with the predetermined potential. Thus, the conductive layer 11 can discharge the charge even when it is irradiated with radiation, so that a breakdown of the insulating layer 16 due to charge-up can be suppressed. Further, it is possible to prevent reduction in radiation detection performance due to an increase in dark current.

Further, if the conductive layer 11 and the first impurity region 18 are set to the same potential, the electric field applied to the insulating layer 16 is reduced, and the dielectric breakdown of the insulating layer 16 can be suppressed more effectively. Furthermore, generation of dark current due to charge accumulation in the insulating layer 16 caused by deterioration of the insulating layer 16 can be effectively suppressed, and as a result, a noise signal due to the dark current can be suppressed.

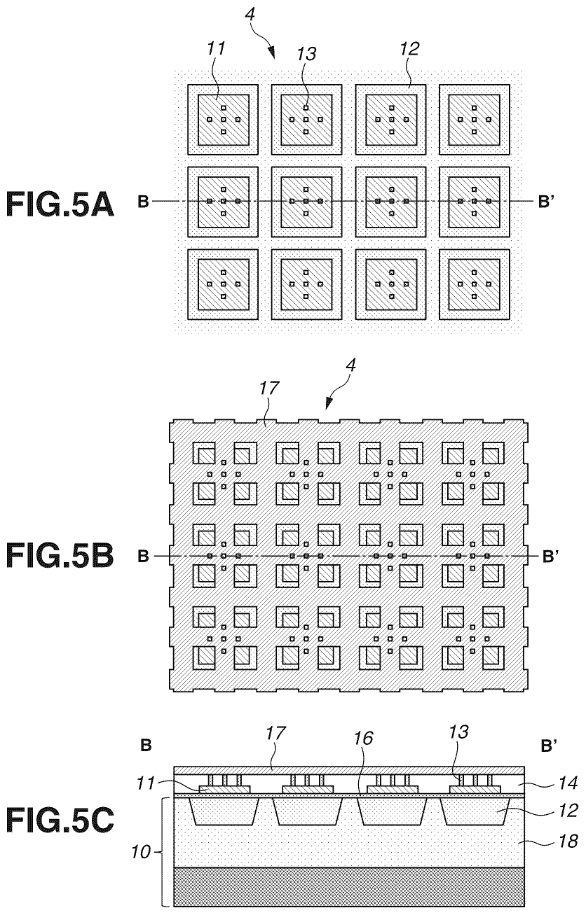

A radiation detector 1 according to a second exemplary embodiment will be described with reference to FIGS. 5A to 5C.

Descriptions of configurations similar to those according to the first exemplary embodiment are omitted.

The radiation detector 1 according to the present exemplary embodiment includes the pixel region 2, the peripheral circuit region 3, and the first buffer region 4 arranged between the pixel region 2 and the peripheral circuit region 3 as with the radiation detector 1 according to the first exemplary embodiment illustrated in FIGS. 1A and 1B. Further, the first buffer region 4 is arranged to surround the pixel region 2.

FIGS. 5A to 5C illustrate the first buffer region 4 according to the present exemplary embodiment. FIG. 5A is a plan view of an example of the radiation detector 1, and the first wiring layer 17 is not illustrated for convenience of description. FIG. 5B is a plan view illustrating the first wiring layer 17 in the configuration in FIG. 5A. FIG. 5C is a cross-sectional view taken along a B-B′ line in FIG. 5B.

In the first buffer region 4 illustrated in FIGS. 5A and 5C, the first impurity region 18 is formed in the semiconductor substrate 10, and a plurality of the insulating materials 12, which is formed simultaneously with the insulating material element isolation portions in the pixel region 2 and the peripheral circuit region 3, is arranged on the first impurity region 18 like islands. Further, the conductive layer 11 is arranged on the insulating material 12. FIG. 5C illustrates an example of a configuration in which the insulating layer 16 is arranged between the conductive layer 11 and the insulating material 12, but the insulating layer 16 may not be provided.

In FIG. 5B, the first wiring layer 17 is arranged in a grid pattern as with the first exemplary embodiment, and flatness of CMP can be secured by adjusting the wiring width to adjust the desired area density.

As with the first exemplary embodiment, flatness of CMP can be secured by adjusting the area density of the insulating material 12 and the conductive layer 11.

Further, as with the first exemplary embodiment, the first wiring layer 17 is arranged on the conductive layer 11 via the interlayer insulating layer 14, and the conductive layer 11 is connected to the first wiring layer 17 via the plug 13. The potential is applied to the first wiring layer 17, and thus the potential is also applied to the conductive layer 11. Thus, as with the first exemplary embodiment, the conductive layer 11 can discharge the charge even when it is irradiated with radiation, so that it is possible to suppress a breakdown of the insulating material 12 and the insulating layer 16 due to charge-up and reduction in imaging performance due to increase in dark current. Generation of dark current can also be suppressed.

Further, the same potential is applied to the first impurity region 18 and the conductive layer 11 to have the same potential, so that the electric field applied to the insulating material 12 and the insulating layer 16 is reduced in the first buffer region 4. Accordingly, it is possible to suppress generation of dark current due to accumulation of charge in the insulating material 12 and the insulating layer 16, and as a result, a noise signal due to the dark current can be suppressed.

As described above, the radiation detector 1 according to the present exemplary embodiment includes the first buffer region 4 and can provide an effect of improving flatness as with the first exemplary embodiment. In addition, the predetermined potential (first potential) is applied to the conductive layer 11 included in the first buffer region 4, so that effects of suppressing the dielectric breakdown of the insulating material 12 and the insulating layer 16 and suppressing dark current can be provided.

Further, according to the present exemplary embodiment, the insulating material 12 is arranged between the conductive layer 11 and the first impurity region 18. Since the insulating material 12 is thicker than the insulating layer 16, the electric field applied between the conductive layer 11 and the first impurity region 18 is reduced more than that according to the first exemplary embodiment, so that a noise signal due to dark current caused by deterioration of the insulating material 12 and the insulating layer 16 can be further suppressed.

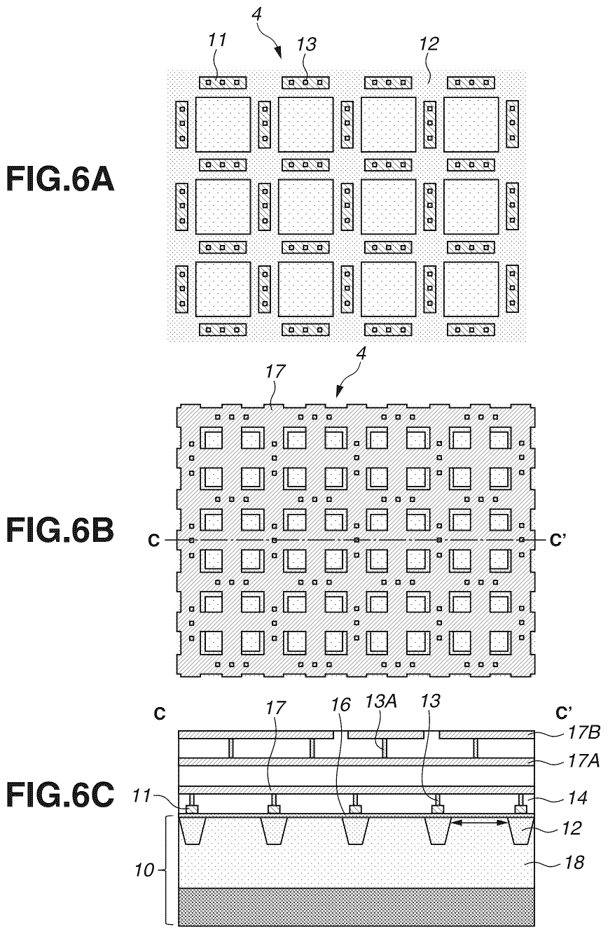

A radiation detector 1 according to a third exemplary embodiment will be described with reference to FIGS. 6A to 6C. Descriptions of configurations similar to those according to the first exemplary embodiment are omitted as appropriate.

The radiation detector 1 according to the present exemplary embodiment includes the pixel region 2, the peripheral circuit region 3, and the first buffer region 4 arranged between the pixel region 2 and the peripheral circuit region 3, and the first buffer region 4 is arranged to surround the pixel region 2 as with the first exemplary embodiment illustrated in FIGS. 1A and 1B.

FIGS. 6A to 6C illustrate the first buffer region 4 according to the present exemplary embodiment. FIG. 6A is a plan view of an example of the radiation detector 1, and the first wiring layer 17 is not illustrated for convenience of description. FIG. 6B is a plan view illustrating the first wiring layer 17 in the configuration in FIG. 6A. FIG. 6C is a cross-sectional view taken along a C-C′ line in FIG. 6B.

In the first buffer region 4 illustrated in FIGS. 6A and 6C, the first impurity region 18 is formed in the semiconductor substrate 10, and the insulating material 12 is arranged in a grid pattern on the first impurity region 18 as with the first exemplary embodiment. Further, as with the second exemplary embodiment, the conductive layer 11 is arranged on the insulating material 12.

The present exemplary embodiment is different from the first and second exemplary embodiments in that the conductive layers 11 are arranged such that a longitudinal direction of the conductive layer 11 is along both a first direction of a grid of the insulating material 12 and a second direction intersecting the first direction. The conductive layers 11 are arranged to surround the first impurity region 18 surrounded by the insulating material 12 in this manner, and thus the area of the conductive layer 11 can be secured, and the area density can be easily adjusted.

Even in the present exemplary embodiment, it is desirable that the area of the conductive layer 11 arranged in the first buffer region 4 is larger than the area of the gate electrode of the transistor in the pixel region 2 in a plan view from the vertical direction to a surface on which the conductive layer 11 of the semiconductor substrate 10 is arranged. According to the present exemplary embodiment, the area of the conductive layer 11 is approximately ten times larger than the area of the gate electrode of the transistor 22 arranged in the pixel region 2. Here, the area of one conductive layer 11 and the area of the gate electrode of the transistor 22 are compared in a plan view.

In FIGS. 6A to 6C, the first buffer region 4 has a configuration in which regions of repeating units having substantially the same configuration are repeatedly arranged. In a case where a plurality of conductive layers 11 is arranged within a region of one repeating unit in this configuration, it is desirable that the area of one conductive layer 11 among the conductive layers 11 arranged in the first buffer region 4 is larger than the area of the gate electrode of the transistor in the pixel region 2 in the plan view. Accordingly, flatness of the interlayer insulating layer 14 arranged on the conductive layer 11 and the transistor in the pixel region 2 can be improved.

FIG. 6C illustrates a configuration in which a wiring layer 17A is arranged on the first wiring layer 17 with the interlayer insulating layer in between, and a wiring layer 17B is further arranged on the wiring layer 17A with the interlayer insulating layer in between. The wiring layers 17A and 17B may be configured to be supplied with the ground potential or the potential (second potential) of the power supply used in the pixel region 2 and the peripheral circuit region 3. Even when the wiring layers 17A and 17B have an island-shaped portion, it is sufficient to connect the island-shaped wiring layers 17A and 17B to other wires via a plug 13A so that they do not become floating.

In this way, even in a case where there are the island-shaped wiring layers 17A and 17B on the first wiring layer 17, the wiring layer is configured to be supplied with a potential and thus can discharge generated charge even if the wiring layer is irradiated with radiation. Thus, the interlayer insulating layer can be prevented from a breakdown due to charge-up. Although it is not illustrated in the first and second exemplary embodiments, if an island-shaped wiring layer is similarly included, a similar effect can be provided by configuring the wiring layer to be supplied with a potential.

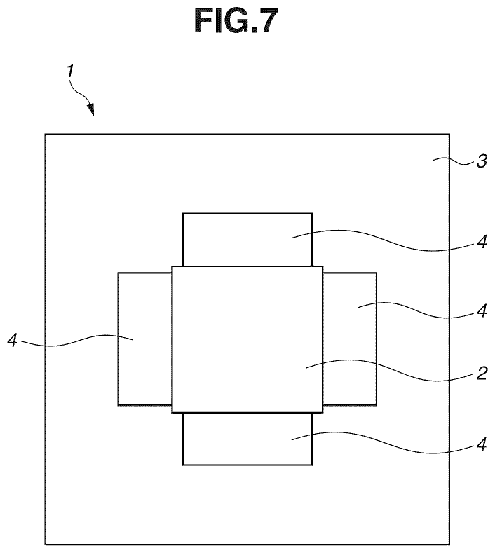

A radiation detector 1 according to a fourth exemplary embodiment will be described with reference to FIG. 7. Descriptions of configurations similar to those according to the first exemplary embodiment are omitted.

In the radiation detector 1 according to the first exemplary embodiment, the first buffer region 4 is arranged to surround the pixel region 2 as illustrated in FIG. 1A but does not necessarily have to surround all sides of the pixel region 2. As in the radiation detector 1 according to the present exemplary embodiment illustrated in FIG. 7, the first buffer region 4 may be arranged between the pixel region 2 and the peripheral circuit region 3, even if it is only partially, and its structure can be adopted by appropriately selecting and combining the configurations according to the above-described first to third exemplary embodiments. Even in this case, an effect of fixing the potential of the dummy conductive layer in the buffer region, which is the effect of the present exemplary embodiment, can be provided.

According to the present exemplary embodiment, it is desirable to arrange circuits and components that are insensitive to radiation irradiation in portions where the first buffer region 4 is not connected, that is, in the peripheral circuit region 3 near four corners of the pixel region 2 in FIG. 7.

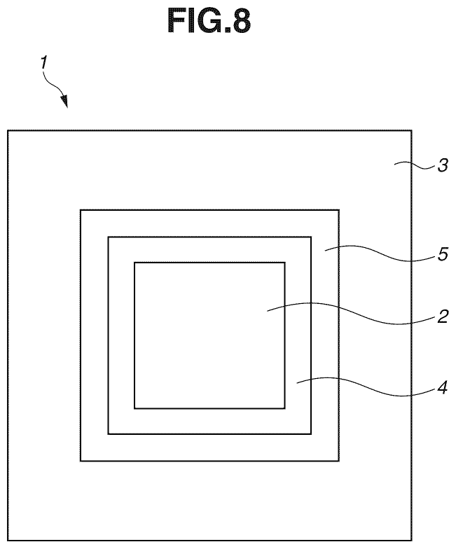

A radiation detector 1 according to a fifth exemplary embodiment will be described with reference to FIGS. 8, 9A, 9B, 9C, 10A, and 10B. Descriptions of configurations similar to those according to the first exemplary embodiment are omitted.

FIG. 8 illustrates an example of the radiation detector 1 according to the present exemplary embodiment. The radiation detector 1 includes the pixel region 2, the peripheral circuit region 3, and the first buffer region (first intermediate region) 4 and a second buffer region (second intermediate region) 5, which are arranged between the pixel region 2 and the peripheral circuit region 3. The first buffer region 4 is arranged to surround the pixel region 2, and the second buffer region 5 is arranged to surround the first buffer region 4.

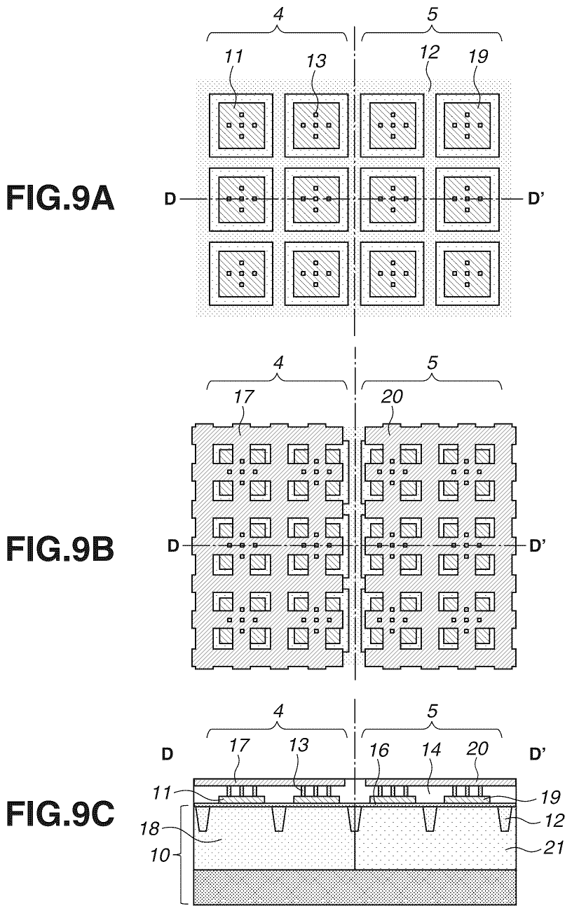

FIGS. 9A to 9C illustrate boundary portions of the first buffer region 4 and the second buffer region 5 according to the present exemplary embodiment. The radiation detector 1 according to the present exemplary embodiment includes the semiconductor substrate 10 made of silicon or the like. FIG. 9A is a plan view of an example of a part of the radiation detector 1, and the first wiring layer 17 and a second wiring layer 20 are not illustrated for convenience of description. FIG. 9B is a plan view illustrating the first wiring layer 17 and the second wiring layer 20 in the configuration in FIG. 9A. FIG. 9C is a cross-sectional view taken along a D-D′ line in FIG. 9B.

In FIGS. 9A and 9C, the insulating material 12 is arranged in a grid pattern as with the first exemplary embodiment, but the present exemplary embodiment is different in that the first buffer region 4 and the second buffer region 5 have separate wells (conductivity type of impurity region). In the semiconductor substrate 10, the first buffer region 4 includes the first impurity region 18, and the second buffer region 5 includes a second impurity region 21.

The conductive layer 11 is arranged on the first impurity region 18 in a region where the insulating material 12 is not arranged. Further, a conductive layer 19 (second conductive layer) that functions as a second dummy conductive layer (second dummy pattern) is arranged on the second impurity region 21 in a region where the insulating material 12 is not arranged.

The first wiring layer 17 is arranged on the conductive layer 11 via the interlayer insulating layer 14, and the conductive layer 11 is connected to the first wiring layer 17 via the plug 13. Further, the second wiring layer 20 is arranged on the conductive layer 19 via the interlayer insulating layer 14, and the conductive layer 19 is connected to the second wiring layer 20 via the plug 13.

The conductive layer 11 and the conductive layer 19 can be formed from, for example, the same conductive film as the gate electrode of the transistor 22 in the pixel region 2 and include the same material. With this configuration, the number of forming processes and materials to be used can be reduced compared with forming the gate electrode of the transistor 22, the conductive layer 11, and the conductive layer 19 in separate processes, and productivity can be improved.

However, the radiation detector 1 according to the present disclosure is not limited to this configuration. The gate electrode of the transistor 22 in the pixel region 2, the conductive layer 11, and the conductive layer 19 may be formed in separate processes, or any two may be formed in the same process, and one of them may be formed in a separate process. Similarly, the other wiring layers may be formed from the same conductive film or may be formed in different processes. By forming the other wiring layers from the same conductive film, the number of processes and amounts of materials to be used can be reduced, and productivity can be improved.

Similarly, the interlayer insulating layer 14 arranged in the first buffer region 4 and the interlayer insulating layer 14 arranged in the second buffer region 5 may be formed in the same process or may be formed in different processes.

A potential of the first impurity region 18 in the first buffer region 4 is set to the ground potential, and thus holes generated in the insulating layer 16 and the semiconductor substrate 10 due to radiation can be discharged, and an influence of dark current on detection performance can be suppressed.

Further, a potential of the second impurity region 21 in the second buffer region 5 is set to the power supply potential, and thus electrons generated by radiation irradiation can be collected. Accordingly, an effect of suppressing an influence of noise on a detection signal of the pixel region 2 can be provided. Further, a malfunction such as a latch-up in the peripheral circuit due to electrons generated in the pixel region 2 going around to the peripheral circuit region 3 can be suppressed.

Conversely, the potential of the first impurity region 18 in the first buffer region 4 may be set to the power supply potential, and the potential of the second impurity region 21 in the second buffer region 5 may be set to the ground potential.

In a case where the first impurity region 18 is a P-type semiconductor and the second impurity region 21 is an N-type semiconductor, it is desirable that the first impurity region 18 is supplied with the ground potential, and the second impurity region 21 is supplied with the power supply potential higher than the ground potential. Further, in a case where the first impurity region 18 is an N-type semiconductor and the second impurity region 21 is a P-type semiconductor, it is desirable that the first impurity region 18 is supplied with the power supply potential higher than the ground potential, and the second impurity region 21 is supplied with the ground potential.

The potential is supplied in this way, and thus, even when an unexpected charge is generated within the semiconductor substrate 10, it can be quickly discharged. Thus, an influence of noise on a detection signal of the pixel region 2 can be suppressed. Further, a malfunction such as a latch-up in the peripheral circuit due to electrons generated in the pixel region 2 going around to the peripheral circuit region 3 can be suppressed.

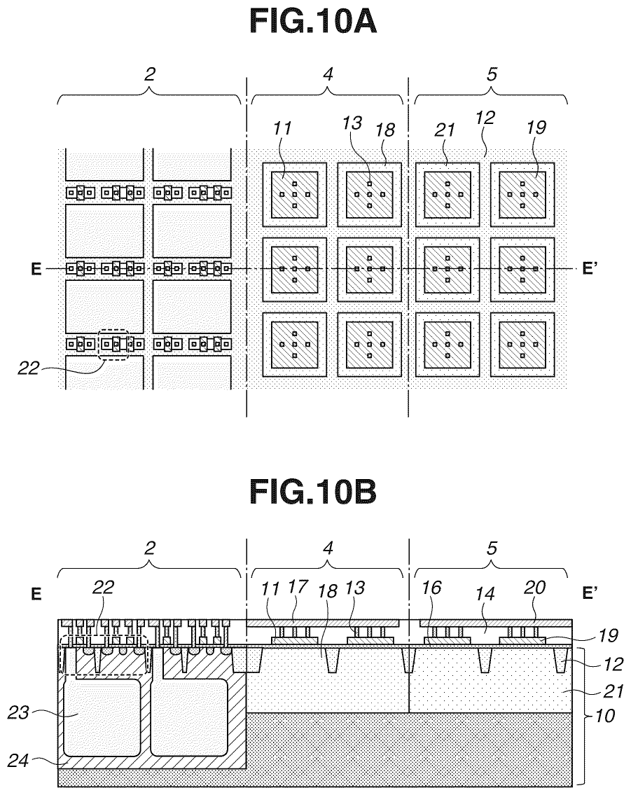

FIGS. 10A and 10B illustrate the pixel region 2, the first buffer region 4, and the second buffer region 5. FIG. 10A is a plan view of an example of a part of the radiation detector 1, and the first wiring layer 17, the second wiring layer 20, and the wiring layer in the pixel region 2 are not illustrated for convenience of description. FIG. 10B is a cross-sectional view taken along an E-E′ line in FIG. 10A. Here, an example is illustrated in which the first buffer region 4 and the second buffer region 5 have the same configuration as illustrated in FIG. 8.

In FIGS. 10A and 10B, the transistor 22 and the detection diode D1 are arranged in the pixel region 2. The detection diode includes the second impurity region 24 and the third impurity region 23.

Since the radiation passes through the transistor 22, the third impurity region 23 for forming the detection diode D1 can be arranged under the transistor 22 as illustrated in FIG. 10B. Further, the second impurity region 24, which is a pixel well, is formed deep in the pixel region 2, so that a size of the detection diode can be increased in a depth direction. With these configurations, the volume of the detection diode D1 can be increased, and the sensitivity of the radiation detector 1 can be increased.

Further, as illustrated in FIG. 10A, an upper surface of the second impurity region 24 in the pixel region 2 includes a region where the insulating material 12 is not provided. Impurity ions are implanted into the region where the insulating material 12 is not provided, so that the third impurity region 23 that configures the detection diode is formed.

The second impurity region 24 and the first impurity region 18 are made by the same conductivity type semiconductor layer, and thus can have the same potential. In this case, the first impurity region 18 can be formed using the same process as a well (impurity region) used in the peripheral circuit region 3.

Accordingly, the first impurity region 18 has a shallower depth from the surface of the semiconductor substrate 10 and a higher concentration of impurity ions than the second impurity region 24. If the concentration of impurity ions is high, the resistance becomes low, so that unnecessary electrons generated in the first impurity region 18 due to radiation irradiation can be collected more quickly. Thus, the potential variation in the first impurity region 18 can be suppressed, and the potential of the second impurity region 24 can be maintained more stable.

In a case where the transistor 22 arranged in the pixel region 2 is an N-type transistor as illustrated in FIG. 2, the second impurity region 24, which is the pixel well in the pixel region 2, and the first impurity region 18 in the first buffer region 4 are P-type semiconductor regions and are applied with the ground potential.

In a case where the first impurity region 18 is the P-type semiconductor region and is applied with the ground potential, even if holes are generated in the insulating layer 16 in the first buffer region 4 and the semiconductor substrate 10 by radiation, the holes can be discharged. Thus, noise caused by dark current due to holes can be prevented from flowing into the detection diode, and an influence on the detection performance of the radiation detector 1 can be suppressed.

On the other hand, the second impurity region 21 in the second buffer region 5 is an N-type semiconductor region and is supplied with the power supply potential higher than the ground potential. The second impurity region 21 applied with the power supply potential can collect electrons even when they are generated in the insulating layer 16 in the peripheral circuit region 3 and the semiconductor substrate 10 by radiation irradiation. Thus, it is possible to prevent a noise signal from being mixed into a pixel signal read out from a pixel in the readout circuit in the peripheral circuit region 3 and to prevent a malfunction such as a latch-up in the vertical scanning circuit.

Since the gate electrode in the pixel region 2 is subject to restriction of the arrangement of the transistor 22, the area density of the gate electrode may be as low as 0.5% to 4%. Thus, the area densities of the conductive layers 11 and 19 are increased to 10% to 80% to compensate for the low area density of the gate electrode in the pixel region 2, and the area of the gate electrode on the entire semiconductor substrate can be adjusted. With this configuration, an etching process of the gate electrode can be performed stably, patterning accuracy of the gate electrode can be improved, and a characteristic variation in the transistor can be suppressed.

According to the present exemplary embodiment, the configuration of the well (impurity region) differs between the first buffer region 4 and the second buffer region 5, and as to other elements such as the insulating material 12 and conductive layers that function as the dummy conductive layers, the configuration according to the first exemplary embodiment illustrated in FIGS. 4A to 4C is applied. In addition to this configuration, the configuration according to the second exemplary embodiment illustrated in FIGS. 5A to 5C and the configuration according to the third exemplary embodiment illustrated in FIGS. 6A to 6C can be applied to the insulating material 12, the conductive layers, and the like.

Further, according to the present exemplary embodiment, an example of the configuration is described in which the shapes and arrangements of the conductive layer 11, the conductive layer 19, the plug 13, the insulating layer 16, and the insulating material 12 are the same in the first buffer region 4 and the second buffer region 5, but they do not necessarily have to be the same. For example, combinations can be appropriately changed, such that the first buffer region 4 has the configuration according to the first exemplary embodiment illustrated in FIGS. 4A to 4C, and the second buffer region 5 has the configuration according to the second exemplary embodiment illustrated in FIGS. 5A to 5C.

As described above, the radiation detector 1 according to the present exemplary embodiment includes the first buffer region 4 and the second buffer region 5 and can provide the same effect as the first exemplary embodiment. Further, the radiation detector 1 according to the present exemplary embodiment can provide an effect of being able to suppress both a defect such as a noise signal and a latch-up due to an electron and a defect such as dark current due to a hole by setting the potentials to be supplied to the first buffer region 4 and the second buffer region 5 to different potentials.

For example, it is configured to supply the ground potential to the impurity region corresponding to one of the wells in the first buffer region 4 and the second buffer region 5, so that holes generated in the insulating layer 16 and the semiconductor substrate 10 by radiation can be discharged, and an influence of dark current on detection performance can be suppressed. In addition, the potential of the well (impurity region) arranged in the pixel region 2 can be stabilized.

At the same time, the impurity region corresponding to the other well in the first buffer region 4 and the second buffer region 5 is set to the power supply potential higher than the ground potential, so that electrons generated by radiation irradiation can be collected. Accordingly, it is possible to suppress an influence of noise on a pixel signal due to the electrons flowing into the pixel region 2 and to suppress mixing of a noise signal due to the electrons generated in the pixel region 2 going around the peripheral circuit region 3 and a malfunction such as a latch-up.

According to the present exemplary embodiment, the case is described in which the second impurity region 24 in the pixel region 2 and the first impurity region 18 in the first buffer region 4 have the same conductivity type, but they may have different conductivity types from each other. Further, the second impurity region 24 in the pixel region 2 and the second impurity region 21 in the second buffer region 5 may have the same conductivity type. With this configuration, effects of suppressing mixing of a noise signal and suppressing a malfunction of the circuit can be provided as with the fifth exemplary embodiment.

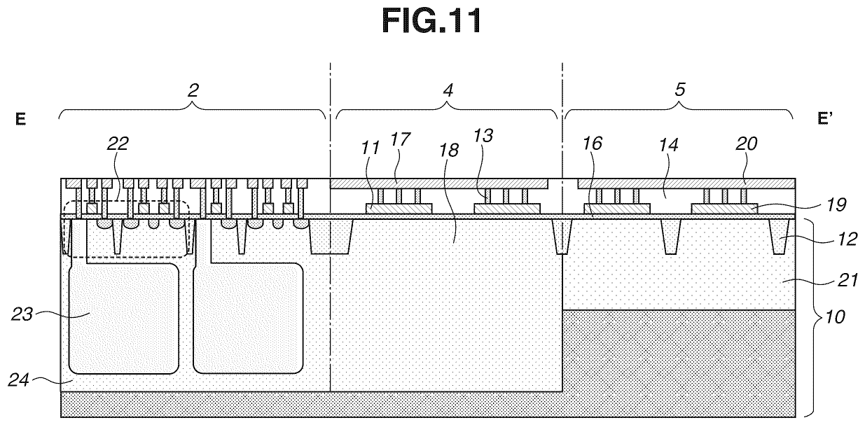

A radiation detector 1 according to a sixth exemplary embodiment will be described with reference to FIG. 11. The present exemplary embodiment is a modification of the configuration according to the fifth exemplary embodiment illustrated in FIGS. 10A and 10B, and descriptions of similar configurations are omitted.

In FIG. 11, the first impurity region 18 (well) in the first buffer region 4 is formed using the same process as the second impurity region 24 in the pixel region 2. Thus, it can be paraphrased that the first impurity region 18 in the first buffer region 4 is a region where the second impurity region 24 in the pixel region 2 extends to the first buffer region 4.

Thus, according to the present exemplary embodiment, the first impurity region 18, which is the first well in the first buffer region 4, is arranged to a deeper position in the semiconductor substrate 10 compared with the first impurity region 18 according to the fifth exemplary embodiment. This configuration is effective in a case where it is desired to particularly suppress an influence of hole generation in a deep part in the semiconductor substrate 10. Since the first buffer region 4 can have the same potential as the second impurity region 24 to the deep part, a potential variation in the second impurity region 24 can be reduced, whereby noise can be suppressed.

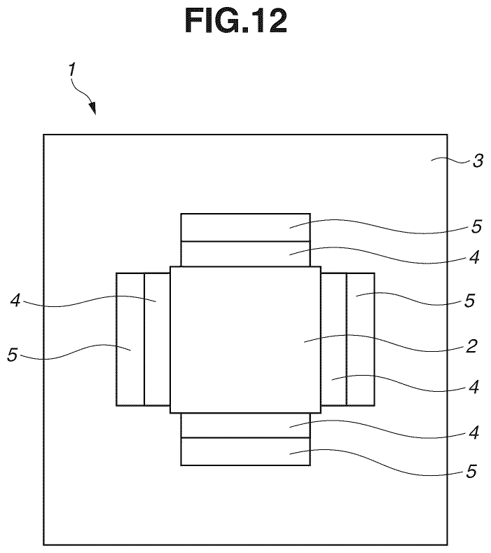

A radiation detector 1 according to a seventh exemplary embodiment will be described with reference to FIG. 12. Descriptions of configurations similar to those according to the fifth exemplary embodiment are omitted.

In the radiation detector 1 according to the fifth exemplary embodiment, the first buffer region 4 and the second buffer region 5 are arranged to surround the pixel region 2 as illustrated in FIG. 8, but they do not necessarily need to surround all sides of the pixel region 2. According to the present exemplary embodiment, the first buffer region 4 and the second buffer region 5 are not arranged in the four corners of the pixel region 2. In this way, as long as the first buffer region 4 and the second buffer region 5 are arranged between the pixel region 2 and the peripheral circuit region 3, even when only partially, the same effect as in the fifth exemplary embodiment can be provided.

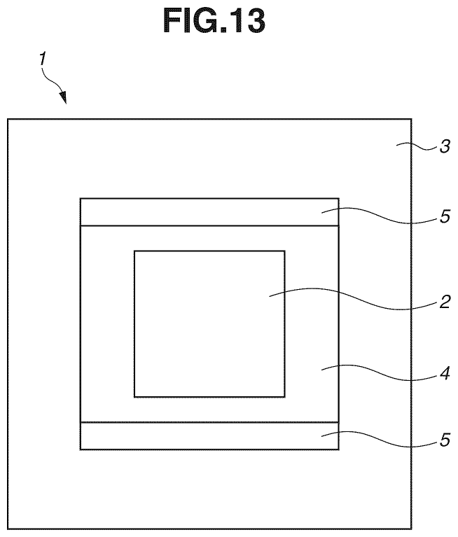

A radiation detector 1 according to an eighth exemplary embodiment will be described with reference to FIG. 13. Descriptions of configurations similar to those according to the fifth exemplary embodiment are omitted.

FIG. 13 illustrates a configuration in which the first buffer region 4 is arranged to surround the pixel region 2, and the second buffer region 5 is partially arranged between the pixel region 2 and the peripheral circuit region 3.

With this arrangement, it is possible to provide an effect of efficiently suppressing noise or malfunction while suppressing an increase in chip area. For example, in a case where the readout circuit exists in the peripheral circuit region 3 adjacent to the second buffer region 5, it is possible to prevent a noise signal from being mixed into a pixel signal read out from a pixel and to prevent a malfunction such as a latch-up if there is the vertical scanning circuit.

In the radiation detector 1 according to the present disclosure, the first buffer region 4 or the second buffer region 5 may be arranged between the pixel region 2 and the peripheral circuit region 3 and is particularly desirable to be arranged at a position where an effect of suppressing noise and a malfunction of the peripheral circuit can be provided.

In addition to the first buffer region 4 and the second buffer region 5, other buffer regions such as a third buffer region and a fourth buffer region may be further provided. A potential to be applied to a conductive layer or a well (impurity region) functioning as a dummy conductive layer in the other buffer regions may be the same as or different from that applied to the first buffer region 4 and the second buffer region 5. Accordingly, it is possible to provide an effect of efficiently suppressing noise and malfunction.

According to the above-described exemplary embodiments, the configuration examples of the radiation detector 1 are described. According to a ninth exemplary embodiment, a radiation imaging system will be described as an example of a detection system provided with the radiation detector 1 according to any of the first to eighth exemplary embodiments. In the detection system according to the present exemplary embodiment, an irradiation unit irradiates a target with an energy ray, and the radiation detector 1 detects the energy ray emitted from the target caused by the irradiation, thereby detecting the energy ray.

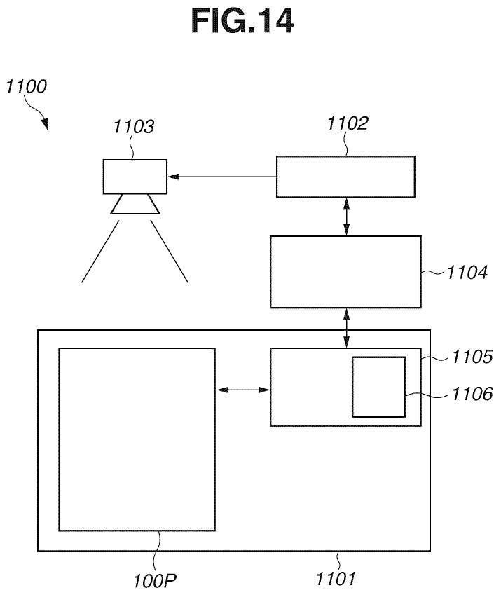

A radiation imaging system 1100 illustrated in FIG. 14 is a detection system that includes an imaging unit 1101, an exposure control unit 1102, a radiation source 1103 as an energy ray irradiation unit, and a computer 1104. The imaging unit 1101 includes an imaging panel 100P equipped with a pixel array. As the imaging unit 1101, any of the radiation detectors 1 described according to the first to eighth exemplary embodiments can be used.

The radiation source 1103 starts radiation irradiation according to an exposure command from the exposure control unit 1102. Radiation emitted from the radiation source 1103 passes through an imaging target (subject) and enters the imaging panel 100P of the imaging unit 1101. The radiation source 1103 stops emitting radiation in accordance with a stop command from the exposure control unit 1102.

The imaging unit 1101 is, for example, a flat panel detector used for radiography in medical image diagnosis and non-destructive testing. The imaging panel 100P of the imaging unit 1101 can have a plate shape with a size that matches a size of an imaging target. For example, the imaging panel 100P includes a substrate of 550 mm*445 mm on which 3300*2800 pixels are arranged. The imaging unit 1101 may include a direct conversion type configuration in which radiation is converted into a signal charge using a detection diode provided in the pixel array of the imaging panel 100P.

As the imaging unit 1101, any of the radiation detectors 1 according to the first to eighth exemplary embodiments can be used. Here, the imaging unit 1101 includes the above-described imaging panel 100P, a control unit 1105 that controls the imaging panel 100P, and a signal processing unit 1106 that processes a signal output from the imaging panel 100P.

The imaging panel 100P includes a plurality of pixels arranged in the pixel region 2 described in any of the first to eighth exemplary embodiments. The signal processing unit 1106 may be the signal processing circuit in the peripheral circuit region 3 according to any of the first to eighth exemplary embodiments. It is not illustrated in here, but the first buffer region 4 according to any of the first to eighth exemplary embodiments is included between the imaging panel 100P and the signal processing unit 1106. The imaging unit 1101 may further include the second buffer region 5.

The signal processing unit 1106 may, for example, perform A/D conversion on a signal output from the imaging panel 100P and output it to the computer 1104 as digital image data. Further, the signal processing unit 1106 may, for example, generate a stop signal for stopping radiation irradiation from the radiation source 1103 based on a signal output from the imaging panel 100P. The stop signal is supplied to the exposure control unit 1102 via the computer 1104, and the exposure control unit 1102 transmits a stop command to the radiation source 1103 in response to the stop signal.

The control unit 1105 may be configured with, for example, one or more processors, a programmable logic device (PLD) such as a field programmable gate array (FPGA), an application specific integrated circuit (ASIC), a general-purpose computer with a built-in program, or a combination of all or a part of these.

According to the present exemplary embodiment, the signal processing unit 1106 is illustrated as being arranged within the control unit 1105 or as being a part of functions of the control unit 1105, but the signal processing unit 1106 is not limited to these. The control unit 1105 and the signal processing unit 1106 may have other configurations. Further, the signal processing unit 1106 may be arranged separately from the imaging unit 1101. For example, the computer 1104 may have functions of the signal processing unit 1106. Thus, the signal processing unit 1106 can be included in the radiation imaging system 1100 as a signal processing apparatus that processes a signal output from the imaging unit 1101.

The computer 1104 can control the imaging unit 1101 and the exposure control unit 1102 and perform processing for receiving radiation image data from the imaging unit 1101 and displaying it as a radiation image. The computer 1104 can also function as an input unit for a user to input a condition for capturing a radiation image.

As an example, the exposure control unit 1102 includes an exposure switch. When a user turns on the exposure switch, the exposure control unit 1102 transmits an exposure command to the radiation source 1103 and also transmits a start notification indicating start of radiation irradiation to the computer 1104. The computer 1104 that has received the start notification notifies the control unit 1105 in the imaging unit 1101 of the start of radiation irradiation in response to the start notification. In response, the control unit 1105 outputs a signal corresponding to the incident radiation on the imaging panel 100P.

In a tenth exemplary embodiment, another example of the detection system provided with the radiation detector 1 according to the first to eighth exemplary embodiments will be described. Also according to the present exemplary embodiment, in the detection system, the irradiation unit irradiates a target with the energy ray, and the radiation detector 1 detects the energy ray emitted from the target caused by the irradiation, thereby detecting the energy ray.

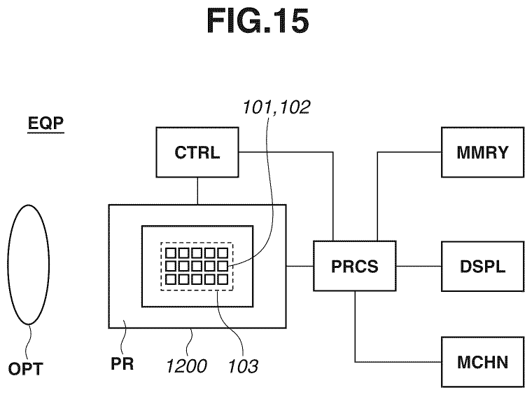

FIG. 15 illustrates equipment EQP as a detection system provided with a radiation detector 1200. As the radiation detector 1200, the radiation detector 1 according to any of the first to eighth exemplary embodiments can be used.

The radiation detector 1200 includes a pixel array 103 in which pixels 101,102 are arranged in a matrix, and a peripheral circuit region PR around the pixel array 103. A peripheral circuit (for example, a vertical scanning circuit and a column circuit portion) can be provided in the peripheral circuit region PR.

A plurality of pixels arranged in the pixel region 2 according to any of the first to eighth exemplary embodiments can be applied to the pixel array 103. Further, the peripheral circuit region 3 according to in any of the first to eighth exemplary embodiments can be similarly applied to the peripheral circuit region PR. Thus, although not illustrated, the first buffer region 4 according to in any of the first to eighth exemplary embodiments is included between the pixel array 103 and the peripheral circuit region PR. The radiation detector 1200 may further include the second buffer region 5.

The equipment EQP can further include at least any one of an optical system OPT, a control apparatus CTRL, a processing apparatus PRCS, a display apparatus DSPL, a storage apparatus MMRY, and a mechanical apparatus MCHN. The optical system OPT forms an image of radiation on the radiation detector 1200 and includes, for example, a lens, a shutter, or a mirror. The optical system OPT may form an image of a particle beam such as an electron beam and a proton beam on the radiation detector 1200 depending on a type of radiation to be used.

The control apparatus CTRL may include one or more processors, circuitry, or combinations thereof and controls the radiation detector 1200 and is, for example, an ASIC or the like. The processing apparatus PRCS may include one or more processors, circuitry, or combinations thereof and processes a signal output from the radiation detector 1200 and is an apparatus such as a central processing unit (CPU), an ASIC, or the like for configuring an analog front end (AFE) or a DFE. The display apparatus DSPL is an electroluminescence (EL) display apparatus or a liquid crystal display apparatus that displays information acquired by the radiation detector 1200 in a form of a visible image or the like.

The storage apparatus MMRY is a magnetic device or a semiconductor device that stores information acquired by the radiation detector 1200. The storage apparatus MMRY is a volatile memory such as a static random access memory (SRAM) and a dynamic random access memory (DRAM), or a nonvolatile memory such as a flash memory and a hard disk drive.

The mechanical apparatus MCHN includes a movable unit or a propulsion unit such as a motor or an engine.

The equipment EQP displays a signal output from the radiation detector 1200 on the display apparatus DSPL and transmits the signal to the outside using a communication apparatus (not illustrated) included in the equipment EQP. Thus, it is desirable that the equipment EQP further includes the storage apparatus MMRY and the processing apparatus PRCS separately from a storage circuit and an arithmetic circuit included in the radiation detector 1200. The mechanical apparatus MCHN may be controlled based on a signal output from the radiation detector 1200.

The equipment EQP illustrated in FIG. 15 may be a medical device such as an endoscope or a radiation diagnostic device, a measurement device such as a ranging sensor, and an analytical device such as an electron microscope.

The detection systems described above according to the ninth and tenth exemplary embodiment are merely examples, and the radiation detector 1 described according to the first to eighth exemplary embodiments may be applied to other detection systems.

The present disclosure is not limited to the above-described exemplary embodiments and can be variously modified within the technical idea of the present disclosure. For example, the present disclosure may be implemented by combining some or all of the different exemplary embodiments described above.

The radiation detector 1 to which the present disclosure can be applied is not limited to a specific form. For example, a light receiving unit that receives radiation may be either a front-illuminated type or a back-illuminated type. Further, the radiation detector 1 may be a stacked radiation detector in which a semiconductor chip including a light receiving unit and a semiconductor chip including a logic unit are stacked.

According to the configurations described in the present disclosure, a radiation detector can be provided which can suppress a breakdown of an insulating layer due to charge-up of a dummy pattern even when the dummy pattern formed with a conductive layer is arranged on the insulating layer in an intermediate region between a pixel region and a peripheral circuit region.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of priority from Japanese Patent Application No. 2023-113804, filed Jul. 11, 2023, which is hereby incorporated by reference herein in its entirety.

What is claimed is:

1. A radiation detector comprising:
a pixel region in which a plurality of pixels is arranged;
a peripheral circuit region in which a signal processing circuit that processes a signal from the plurality of pixels is provided; and
a first intermediate region arranged between the pixel region and the peripheral circuit region,
wherein each of the plurality of pixels includes:
a radiation detection element provided on a semiconductor substrate; and
a transistor that outputs a signal corresponding to a charge accumulated in the radiation detection element,
wherein, in the pixel region, the first intermediate region, and the peripheral circuit region, an insulating layer is arranged on the semiconductor substrate, and an interlayer insulating layer is arranged on the insulating layer,
wherein the transistor includes a gate electrode provided on the insulating layer,
wherein the first intermediate region includes a first conductive layer arranged in contact with the insulating layer,
wherein the first conductive layer is configured to be supplied with a first potential, and
wherein a distance between the pixel region and the peripheral circuit region is 200 um (micrometers) or more.

2. The radiation detector according to claim 1, wherein the first conductive layer includes polysilicon.

3. The radiation detector according to claim 1, wherein an area of the first conductive layer is different from an area of the gate electrode in one pixel included in the plurality of pixels in a plan view from a vertical direction to a surface of the semiconductor substrate on which the first conductive layer is arranged.

4. The radiation detector according to claim 3, wherein the area of the first conductive layer is larger than the area of the gate electrode in the one pixel in the plan view.

5. The radiation detector according to claim 3, wherein the area of the first conductive layer is twice or more the area of the gate electrode in the one pixel in the plan view.

6. The radiation detector according to claim 1, wherein a first wire is arranged on the interlayer insulating layer, and the first conductive layer is connected to the first wire.

7. The radiation detector according to claim 1,
wherein, in the first intermediate region, the semiconductor substrate includes a first impurity region that is arranged in contact with the insulating layer and has a first conductivity type, and
wherein the first impurity region is configured to be supplied with the first potential.

8. The radiation detector according to claim 7,
wherein, in the pixel region, the semiconductor substrate includes a second impurity region having the first conductivity type and a third impurity region that is arranged within the second impurity region and has a second conductivity type different from the first conductivity type, and
wherein the second impurity region is configured to be supplied with the first potential.

9. The radiation detector according to claim 1, wherein the first potential is a ground potential.

10. The radiation detector according to claim 1, wherein the first intermediate region includes an insulating material arranged on the semiconductor substrate, and the first conductive layer is arranged on the insulating material.

11. The radiation detector according to claim 10, wherein the insulating material is at least one of local oxidation of silicon and shallow trench isolation.

12. The radiation detector according to claim 1,
wherein a second intermediate region is included between the peripheral circuit region and the first intermediate region,
wherein the second intermediate region includes a second conductive layer arranged on the insulating layer,
wherein the interlayer insulating layer covers the second conductive layer, and
wherein the second conductive layer is configured to be supplied with a second potential different from the first potential.

13. The radiation detector according to claim 12, wherein the second potential is higher than the first potential.

14. The radiation detector according to claim 12, wherein the second potential is a power supply potential to be input to any wire of the signal processing circuit.

15. The radiation detector according to claim 12, wherein the second intermediate region is arranged between the peripheral circuit region and the first intermediate region.

16. The radiation detector according to claim 8, wherein the first impurity region and the second impurity region are electrically connected.

17. A detection system comprising:
an irradiation unit configured to irradiate a target with an energy ray; and
the radiation detector according to claim 1,
wherein the radiation detector detects an energy ray travelling from the target to the radiation detector.

18. A radiation detector comprising:
a pixel region in which a plurality of pixels is arranged;
a peripheral circuit region in which a signal processing circuit that processes a signal from the plurality of pixels is provided; and
a first intermediate region arranged between the pixel region and the peripheral circuit region,
wherein each of the plurality of pixels includes:
a radiation detection element provided on a semiconductor substrate; and
a transistor that includes a gate electrode and outputs a signal corresponding to a charge accumulated in the radiation detection element,
wherein the first intermediate region includes an insulating layer arranged on the semiconductor substrate and a first conductive layer that is arranged on the insulating layer and includes polysilicon,
wherein an interlayer insulating layer is arranged on the radiation detection element, the transistor, and the first conductive layer,
wherein the first conductive layer is configured to be supplied with a first potential, and
wherein a distance between the pixel region and the peripheral circuit region is 200 um (micrometers) or more.

19. The radiation detector according to claim 18,
wherein, in the pixel region, the first intermediate region, and the peripheral circuit region, the insulating layer is arranged on the semiconductor substrate, and
wherein, in the first intermediate region, the first conductive layer is arranged on the semiconductor substrate with the insulating layer in between.

20. A detection system comprising:
an irradiation unit configured to irradiate a target with an energy ray; and
the radiation detector according to claim 18,
wherein the radiation detector detects an energy ray travelling from the target to the radiation detector.
